(19) United States
(12) Patent Application Publication
(10) Pub. No.: US 2026/0288349 A1
(43) Pub. Date: Sep. 24, 2026

(54) NVME DRIVE TRACKING ACROSS A DISTRIBUTED SYSTEM

(71) Applicant: Dell Products L.P., Round Rock, TX (US)

(72) Inventors: PHANINDRA BHARGAV TALASILA, Georgetown, TX (US); IBRAHIM SAYYED, Georgetown, TX (US); ADOLFO SANDOR MONTERO, Pflugerville, TX (US); XIAOMEI ZHU MILLER, Round Rock, TX (US)

(21) Appl. No.: 19/085,625

(22) Filed: Mar. 20, 2025

(51) Int. Cl. G06F 3/06

(52) U.S. Cl. CPC G06F 3/0622; G06F 3/0652; G06F 3/0679

(57) ABSTRACT

Methods and systems for managing operation of a data processing system are disclosed. To do so, a management controller of the data processing system may make a determination that a new storage device is operably connected to hardware resources of the data processing system; and based on the determination, data usable to identify whether the storage device is a stolen storage device may be obtained by the management controller and via a side-band channel. The management controller may then manage operation of the storage device based on an inferred status of the storage device that is based on the data.

### FIELD

Embodiments disclosed herein relate generally to managing operation of data processing systems. More particularly, embodiments disclosed herein relate to managing device tracking across a distributed system for data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2D show interaction diagrams in accordance with an embodiment.

FIG. 3 shows a flow diagram illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary de vices, such as in a network topology.

In general, embodiments disclosed herein relate to methods and systems for managing operation of a data processing system within a distributed environment that may include any number of data processing systems (e.g., that relate to methods and systems for managing operation of a distributed system). The (any number of) data processing systems may provide computer-implemented services to any type and/or number of other devices and/or users of the data processing systems. The computer-implemented services may include any quantity and type of such services.

To provide the computer-implemented services, the data processing systems may each include any number of hardware components whose respective operation may facilitate various functionalities of the data processing systems. For example, any one of the data processing systems may include any number of storage devices for storing data and allowing future access to this stored data by processes performed by the any one of the data processing systems.

For example, a user of one of the data processing systems may store a number of personal documents and media files on an NVMe storage device while this NVMe storage device is operably connected to a first data processing system. The user may then continue to access these personal documents and media files for any number of reasons not to be limited by embodiments discussed herein. This continued access may be made possible due to the allocation of physical storage space of the NVMe storage device for the personal documents and media files to be recorded/committed to.

However, assume that this NVMe storage device is obtained by a malicious entity without the user's knowledge when the malicious entity disconnects the NVMe storage device from the first data processing system. Consequently, should the malicious entity's intention be to obtain any portion of the personal documents and/or the media files to glean private information regarding the user, such gleaned private information may be used without the user's knowledge and/or may be used to the user's detriment (e.g., using such private information with disregard for the user's privacy).

To do so, the malicious entity may, for example, operably connect the NVMe storage device to a second data processing system in an attempt to access the stored data. This second data processing system may, however, identify the NVMe storage device, but be unable to recognize the NVMe storage device as having been previously operably connected to the second data processing system. In such cases, a management controller of the second data processing system may obtain data (i) associated with the NVMe storage device and/or (ii) that may be used to otherwise identify and/or discern the NVMe storage device from other storage devices. This obtained data may then be used to infer a status of the NVMe storage device regarding, for example, whether the NVMe storage device is a stolen storage device. The NVMe storage device may then have its operation managed based on the inferred status.

Thus, embodiments disclosed herein may provide a method for managing, by a management controller, operation of a data processing system by utilizing sideband communication channels to determine (e.g., infer) a status of a storage device that is newly (and operably) connected to a data processing system. This status may then, for example, be used to manage operation of the storage device specifically. By doing so, a likelihood of data stored on the storage device being used in an unauthorized manner (such as without the user's knowledge and/or with disregard to the user's privacy) may be decreased.

In an embodiment, a method for managing operation of a data processing system is provided.

The method may include making by a management controller of the data processing system, a determination that a new storage device is operably connected to hardware resources of the data processing system; and based on the determination: obtaining, by the management controller and via a side-band channel, data usable to identify whether the storage device is a stolen storage device; and managing, by the management controller, operation of the storage device based on an inferred status of the storage device that is based on the data.

The data may be an identifier usable to uniquely discriminate the storage device from all other storage devices.

Managing the operation of the storage device may include comparing the identifier to a ledger of identifiers of stolen storage devices to confirm whether the storage device is the stolen storage device; and in an instance of the comparing where the storage device is the stolen storage device: performing at least one management action to limit impacts of unauthorized distribution of data stored on the storage device.

The at least one management action may include disabling the operation of the storage device so that the hardware resources are unable to interact with the storage device.

The at least one management action may include encrypting at least a portion of data stored on the storage device using an encryption key that is unavailable to the hardware resources.

The at least one management action may include deleting at least a portion of data stored on the storage device so that the at least a portion of data is unavailable to the hardware resources.

Managing the operation of the storage device may further include in a second instance of the comparing where the storage device is neither confirmed as being the stolen storage device nor not being the stolen storage device: performing at least one second management action to collect information regarding use of the storage device to proactively manage undesired activity in an event that it is determined in the future that the storage device is the stolen storage device.

The data may be at least one portion of content from the storage device.

Managing the operation of the storage device may include comparing the at least one portion of content to portions of content from the hardware resources to confirm whether the storage device is the stolen storage device; and in an instance of the comparing where the storage device is the stolen storage device: performing at least one management action to limit impacts of unauthorized distribution of data stored on the storage device.

The management controller may operate independently from and may be distinct from the hardware resources.

The management controller may be on a separate power domain from the hardware resources so that the management controller may be operable while the hardware resources are inoperable.

In an embodiment, a non-transitory media is provided. The non-transitory media may include instructions that when executed by a processor cause the computer-implemented method to be performed.

In an embodiment, a system is provided. The system may include the non-transitory media and a processor and may perform the computer-implemented method when the computer instructions are executed by the processor.

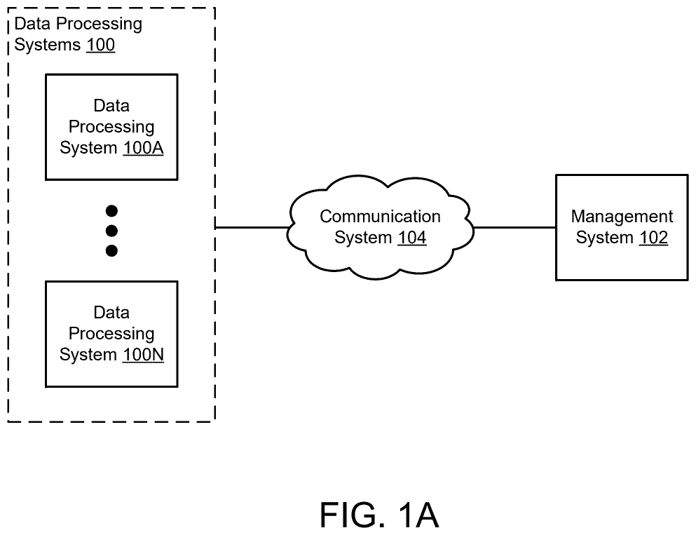

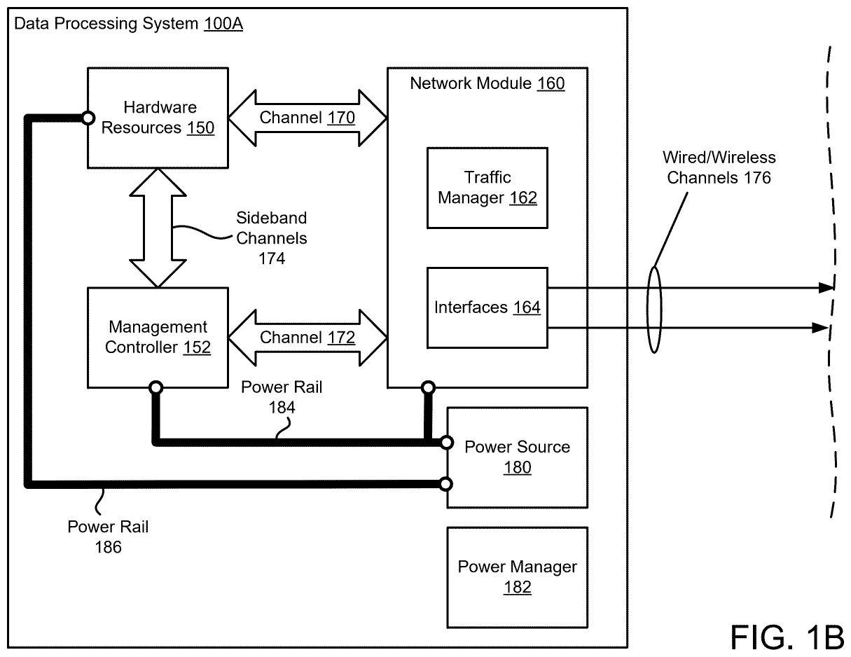

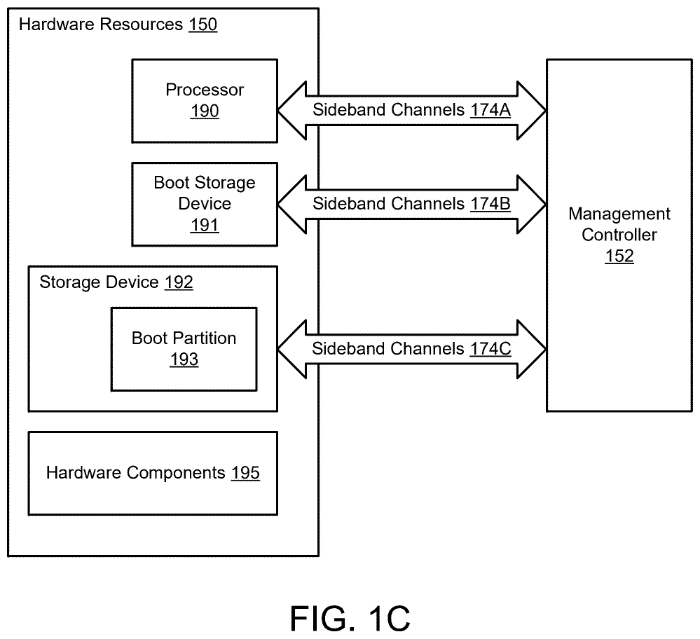

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not explicitly shown in FIG. 1A). Other types of computer-implemented services may be provided by the (distributed) system shown in FIG. 1A without departing from embodiments disclosed herein.

The computer-implemented services may be provided, at least in part, by hardware resources of any of data processing systems 100 (e.g., each and/o any of 100A-N). To provide the computer-implemented services reliably, a data processing system (e.g., 100A) may, throughout its operation, utilize sideband communication channels adapted to facilitate communication between at least some of the hardware resources without use of (e.g., not via) in-band communication channels of the data processing system. For example, assume that the data processing system is powered on (e.g., the power button must have been pushed) and a booting process is initiated. This booting process may be performed, at least in part, by a management controller of the system and a processor of said system to initialize operation of the hardware resources. To do so, for example, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band channels) and an operating system may be loaded to provide management functionality.

However, to further discuss this example, assume an undesired boot event may occur. This undesired boot event may be, for example, when the processor is unable to perform the booting process using the boot data stored on the boot storage device. For example, the processor may be unable to perform the booting process when at least one copy of the boot data hosted by the boot storage device includes erroneous data (e.g., corrupted firmware, malicious data, incompatible firmware version, etc.), a firmware image is improperly flashed on the boot storage device, and/or any other causes impacting an ability of the processor to perform the booting process occur. Consequently, the at least a portion of the hardware resources may be inoperable and/or may otherwise not operate in a desirable manner.

To modify operation of the data processing system in an event of compromise and/or reduced functionality of at least a portion of the hardware resources, the data processing system may host a management controller that may operate independently from the hardware resources and may (i) be distinct from, and (ii) adapted to manage, the hardware resources. For example, the management controller may operate in a consistent/expected manner during the booting process and/or regardless of an outcome of the booting process performed by booting components (e.g., the boot storage device and/or the processor) of the hardware resources due to facilitating operations via sideband channels.

In general, embodiments disclosed herein relate to systems, devices, and methods for managing operation of a data processing system. To manage the operation of the data processing system (e.g., 100A), the management controller may utilize sideband channels for communication rather than using the previously mentioned in-band channels. In doing so, stable, consistent, and likely to be desirable operation of the management controller is likely to be facilitated and maintained. Such operation may thereby mitigate operation within the distributed system deemed undesirable, unpredictable, and/or that may otherwise negatively impact the providing of the computer-implemented services.

The storage device may include a non-volatile memory (NVMe) storage device that may include, for example, a boot partition (e.g., a section of the storage device allocated to store data relevant to the booting process). The management controller may provide and/or obtain (e.g., read and/or write) data from the boot partition using a (e.g., second) sideband channel for communication that is distinct from a (e.g., first) sideband channel that may be used to communicate to the (central) processor of the data processing system.

To provide the above noted functionality, the system may include data processing systems 100, management system 102, and communication system 104. Each of these is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band (e.g., “sideband”) communication channel.

While providing the at least a portion of the computer-implemented services, a data processing system (e.g., 100A) of data processing systems 100 may communicate with and/or obtain information from management system 102. For example, data processing system 100A may obtain (i) instructions relevant to updating operation of the hardware resources (e.g., update firmware, configurations, accessibility, etc.), (ii) management requests to modify operation of the hardware resources (e.g., installing new applications), and/or (iii) any other information not to be limited by embodiments discussed herein. Data processing system 100A may subsequently perform actions based on the information obtained from and/or by management system 102 to update operation of data processing system 100A.

Management system 102 may, as discussed above, provide remote management services. Management system 102 may include a second data processing system operated by, for example, an owner of data processing systems 100. To provide the remote management services, management system 102 may interact with data processing systems 100 to obtain and/or provide information (e.g., data) relevant to operation of data processing systems 100 (and/or components thereof).

For example, management system 102 may include access to a database/repository of status-based data regarding any number of devices. Portions of this status-based data may be based on, for example, a likelihood of whether a device of any type or quantity, such as the previously mentioned NVMe storage device, has been stolen (e.g., devices determined to have likely been stolen may be regarded as stolen devices).

Therefore, management system 102 may provide a portion of the status-based data to any of data processing systems 100, for example, based on a request from any of the of data processing systems. Additionally, based on communication with the any of data processing systems 100, management system 102 may update status-based data included in the database/repository, and/or facilitate other processes for any number of purposes not to be limited by embodiments discussed herein.

Thus, while providing their functionality, any of data processing systems 100 and management system 102 may provide all or a portion of the methods shown and/or discussed herein with regard to FIGS. 1A-3.

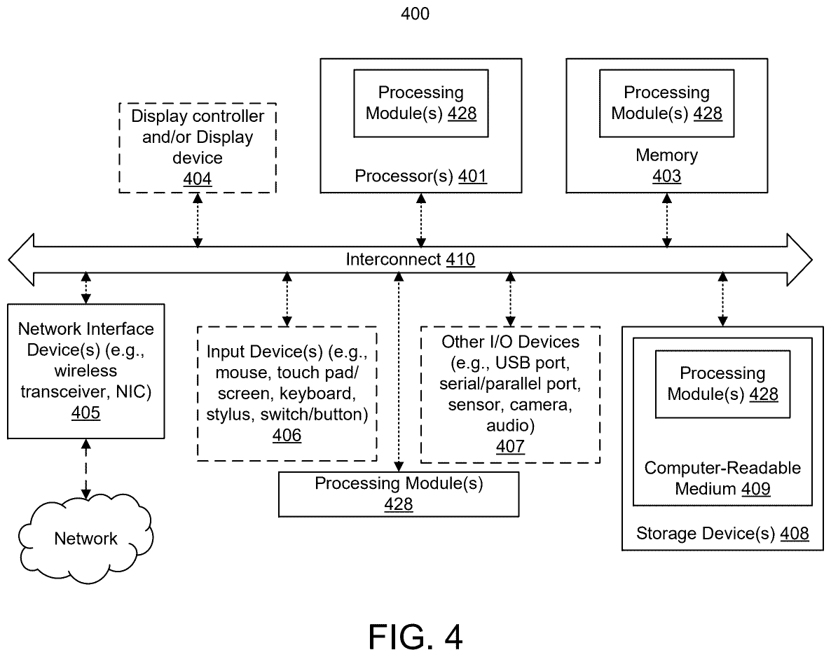

Communication system 104 may allow any of data processing systems 100, and management system 102 to communicate with one another (and/or with other devices not explicitly illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or any components thereof) data processing systems 100 and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by restoring boot data hosted on a boot storage device of the data processing system when an undesired boot event is identified by a management controller of the data processing system. By doing so, the data processing system may be rebooted using the boot data to place the data processing system in desired operating state.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express (NVMe) protocols) that may facilitate use of storage resources of the storage device.

For example, the storage may include a first storage device adapted to host an image of a startup management entity (e.g., basic input/output system (BIOS)), system configurations, and/or any other information. Additionally, the storage may include a second storage device that may include but is not to be limited by this discussion to include, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack for communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150 of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

Because an ability of management controller 152 to provide the management functionalities may be limited when the data exceeds storage capacity of storage resources hosted by the management controller, management controller 152 may utilize any number and/or types of storage devices hosted by hardware resources 150.

To do so, management controller 152 may be operably connected to various components via side band channels 174 (in FIG. 1B, a limited number of side band channels are included for illustrative purposes, it will be appreciated that management controller 152 may establish/use communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may (i) communicate (e.g., obtaining and/or providing) information relevant to identifying a status of a storage device, (ii) manage (e.g., delete, update, and/or make inaccessible and/or make more accessible) data that is stored on the storage device of hardware resources 150, (iii) attempt to prevent unauthorized use of devices and/or data used/stored by the devices, and/or (iv) performing any other actions.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and/or other hosted components may not result in (indirect) compromise of management controller 152, nor entities hosted by management controller 152.

For example, storage devices of hardware resources 150 may not be operably connected to a processor (e.g., due to in-band channels between the processor and the storage devices not being functional during the booting process). Management controller 152 may communicate with the processor, the boot storage device, and the storage device via side band channels 174. By doing so, management controller 152 may obtain and perform management functionalities (e.g., detecting a system hang during booting, obtaining data from a storage device, managing various types of data on the boot storage device or any other storage device, etc.) regardless of an operating state of hardware resources 150.

To facilitate communication with other devices, data processing system 100A may include network module 160. Network module 160 may provide communication services for in-band components and out-of-band components (e.g., management controller 152) of data processing system 100A. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may be independently addressable and that may be otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

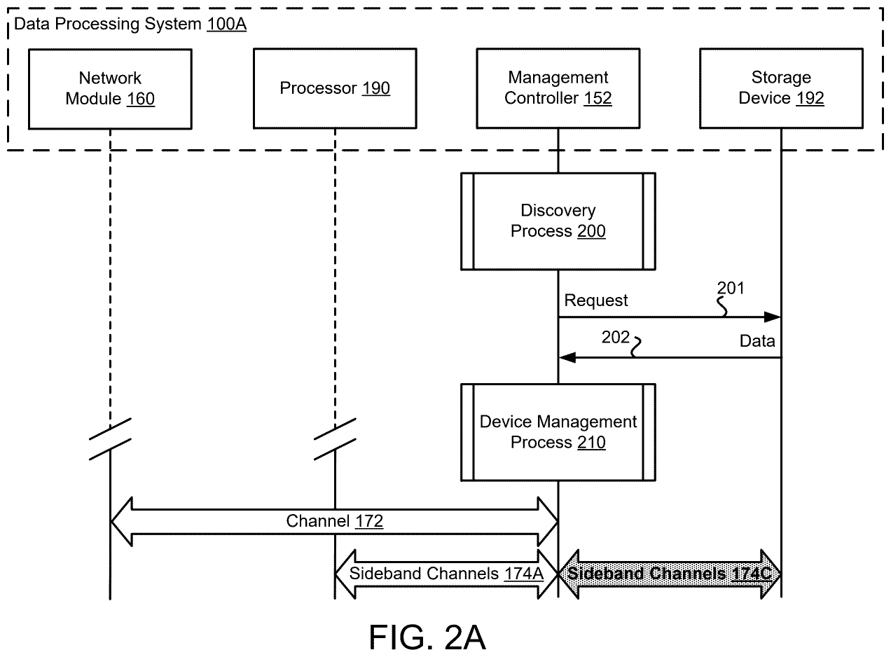

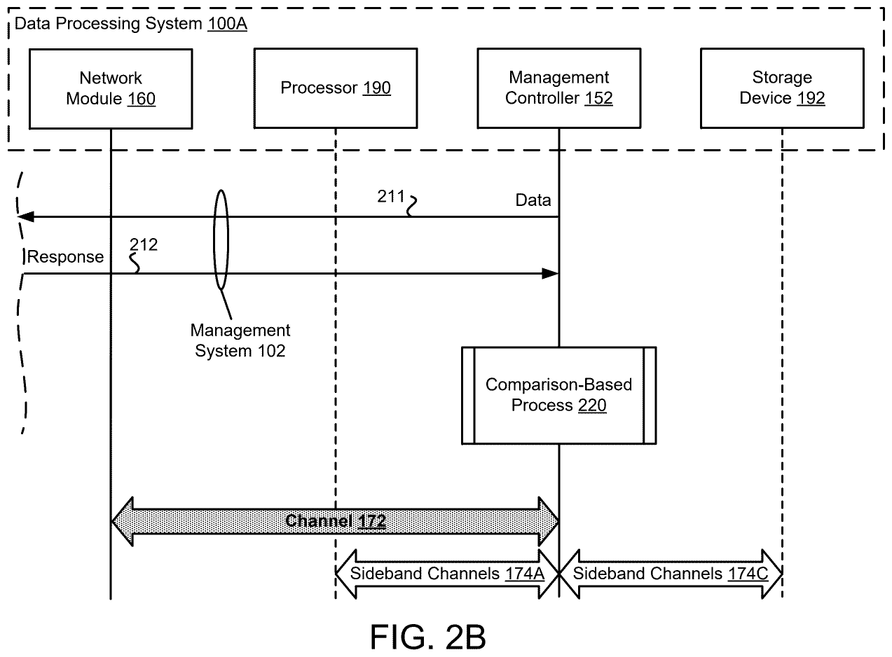

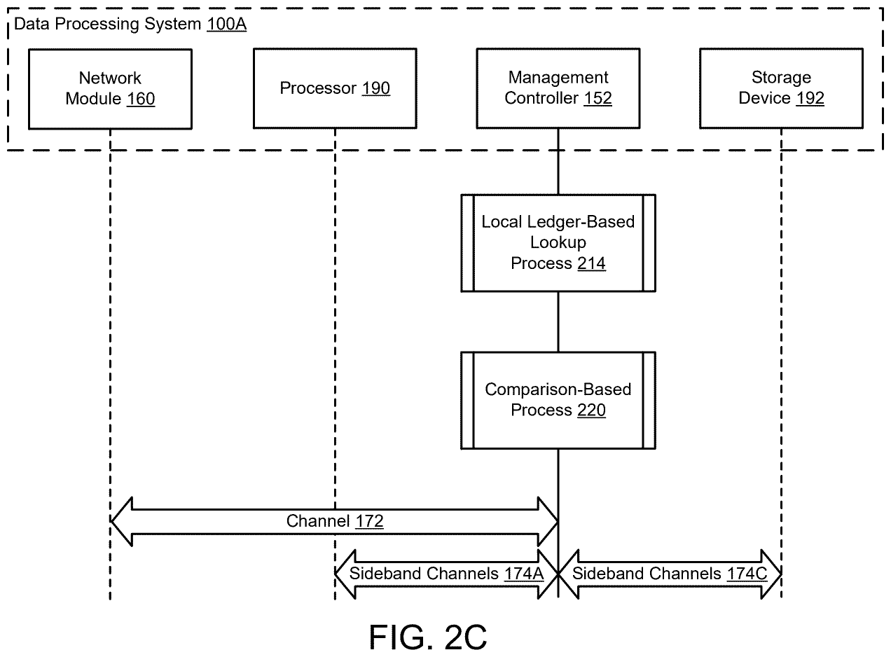

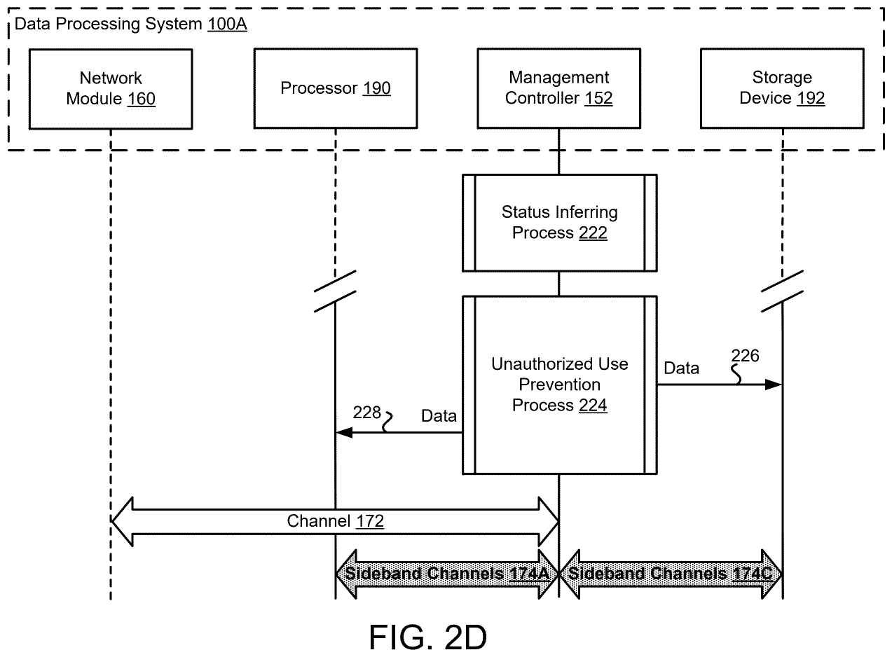

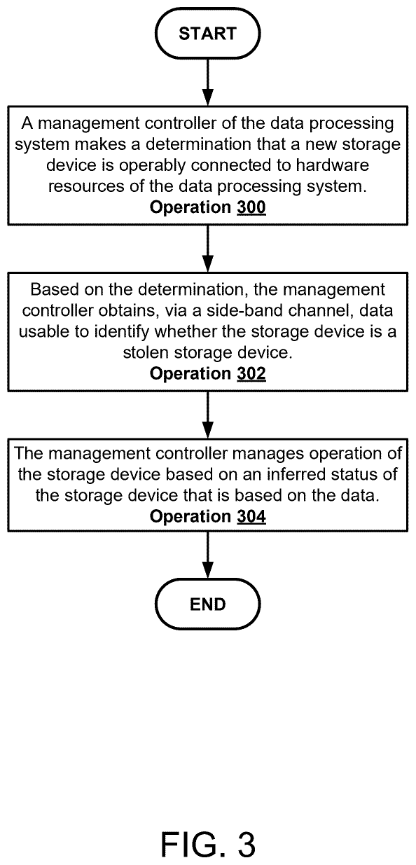

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data that may also be stored on storage device 192 along with various possibly unrelated-to-booting data files such as an individual user of data processing system 100A's personal documents and/or media files).

Storage device 192 may include, for example, a second storage device such as a non-volatile memory express (NVMe) based solid-state drive. Storage device 192 may include a boot partition (193) that may be configured to store data usable to boot data processing system 100A (e.g., a latest stable copy of boot data, bootloader files, configuration files, etc.). Boot partition 193 may include an allocated section of storage device 192 that may, for example, be isolated from other memory sections of storage device 192 (e.g., the other memory sections having been allocated for the personal documents and/or media files).

Processor 190 may include a central processing unit (CPU) that may interact with any number and/or type of other hardware components (e.g., boot storage device 191, storage device 192, and hardware components 195).

For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired boot (or an unrelated-to-booting) event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and otherwise placed in the desired operating state, management controller 152 may perform management functionalities using any number and/or type of side band channels such as 174 (e.g. 174A-174C). For example, management controller 152 may obtain and/or provide information (e.g., telemetry data, process results, boot times, other and/or additional data allocated to storage, etc.) to (i) processor 190 using side band channel 174A, (ii) boot storage device 191 using sideband channel 17B, (iii) boot partition 193 of storage device 192 using side band channel 174C, and/or (iv) any other components of hardware resources 150 regardless of an overall operating state (status) of data processing system 100A.

To further clarify embodiments disclosed herein, interaction diagrams in accordance with an embodiment are shown in FIGS. 2A-2D. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 190, 152, 192, etc.), located towards the top of each figure. Lines descend from these shapes. Processes performed by the components of the system are illustrated using a second set of shapes (e.g., 200, 210, etc.) superimposed over these lines. Interactions (e.g., communication, data transmissions, etc.) between the components of the system are illustrated using a third set of shapes (e.g., 201, 202, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Out-of-band communication channels (e.g., sideband channels) that operably connect various components of the system with one another are illustrated using a fourth set of shapes (e.g., 172, 174A, and 174C) that extend between the lines. The fourth set of shapes may include large double ended arrows that indicate use of a sideband channel between two of the components.

Generally, the processes and interactions are temporally ordered in an example order, with time increasing from the top to the bottom of each page. For example, the process labeled as 201 may occur prior to the interaction labeled as 202. However, it will be appreciated that the processes and interactions may be performed in different orders, any may be omitted, and other processes or interactions may be performed without departing from embodiments disclosed herein.

The lines descending from some of the first set of shapes (e.g., 160, 190, 152, and 192) are drawn in dashing to indicate, for example, that the corresponding components may not be (i) operable, (ii) powered on, (iii) present in the system, and/or (iv) not participating in operation of the system for other reasons. (e.g., not being utilized by, for example, a management controller using an out-of-band communication channel). This dashing may alternate back to the original solid (e.g., non-dashed) characteristic of the descending lines and vice versa any number of times.

The change between the original solid and the dashing as the lines descend may be marked by diagonal, yet parallel with regard to one another, lines that cut the descending lines as they change. Such marked cuts along the descending lines are drawn to indicate, for example, moments of change where a management controller (e.g., 152) may utilize respective out-of-band communication channels to (i) interact with various components of a (potentially compromised) data processing system, or (ii) cease interaction with any of the various components.

It will also be appreciated that utilization of such out-of-band communication channels may be facilitated for security purposes. For example, and generally, a processor of the data processing system may perform functionalities for a booting process that include taking inventory of any and all operably connected devices. However, under a preventative assumption in which the data processing system may be assumed to be otherwise compromised. For example, if in a malicious entity's control, any number of security features and/or configurations of the system may be bypassed, deprecated, etc. Consequently, communications that may be intercepted and/or otherwise perverted via in-band channels during management of newly connected devices may instead be isolated when via sideband channels that prevent such interference. Such sideband channels may be in active use for processes discussed in each interaction diagram, indicated by any of the fourth shapes being illustrated with shaded in-fill.

Turning to FIG. 2A, a first interaction diagram in accordance with an embodiment is shown. The first interaction diagram may illustrate processes and interactions that may occur during management of a data processing system's operation when a (new) storage device is discovered to be operably connected to the data processing system.

To manage such operation, management controller 152 may perform (e.g., automatically) discovery process 200. During discovery process 200, management controller 152 may, for example, make a determination that a new (e.g., initially unknown) storage device is operably connected to the host data processing system (e.g., 100A) for a first time.

As shown in FIG. 2A, for example, assume this new storage device is storage device 192. The determination may be made by utilizing an infrastructure of the host data processing system (e.g., 100A) in which management controller 152 (i) operates independently from and is distinct from hardware resources of the host data processing system, and (ii) is on a separate power domain from the hardware resources so that management controller 152 is operable should the hardware resources be or become inoperable. For example, this infrastructure may allow management controller 152 to become aware of the new operable connection as it may with any instance of a device's operable connection to the host's hardware resources. Consequently, however, due to storage device 192 being new to the host's system environment, management controller 152 may not be able to initially identify what storage device 192 is (e.g., may be unable to identify a type of the newly connected device).

For example, management controller 152 may rely on stored records regarding previously connected devices to facilitate automatic identification of said devices. For example, during any instance of such familiar device's operable reconnection, management controller 152 may automatically identify the familiar device as well as correctly configure optimal communication channels based on the stored records. Therefore, because storage device 192 may not be associated with any information stored in such records due to its current operable connection to the host being a first time ever connecting to this host, management controller 152 may further utilize the host's infrastructure as discussed below.

Thus, based on the determination that an otherwise unknown device is operably connected to the host, management controller 152 may further utilize the host's infrastructure as well as existing configurations to establish an out-of-band communication with storage device 192. For example, such communication may be established via sideband channels 174C and used to obtain information regarding storage device 192 as discussed below with regard to interactions 201 and 202.

At interaction 201, management controller 152 may request information regarding the new device from storage device 192. Such a request may be provided by utilizing sideband channels 174C to transmit the request as digital data (e.g., commands, instructions, etc.) that is likely to be understood by a controller (e.g., independent processor) of storage device 192 adapted to manage operation of storage device 192.

Based on the request, the controller of storage device 192 may locate device data (e.g., data regarding storage device 192) that has been allocated to a portion of storage device 192's physical memory, this device data being usable to discern storage device 192 from other storage devices. Once located, the device data may be used to service management controller 152's request for the information. For example, this request may be serviced as discussed below with regard to interaction 202.

At interaction 202, the controller of storage device 192 may initiate a transmission of data to management controller 152, the transmission (i) including the device data and (ii) facilitated via sideband channels 174C.

To be used to discern storage device 192 from other storage devices, this device data may include, for example, (i) an identifier usable to uniquely discriminate storage device 192 from all other storage devices, and/or (ii) at least one portion of content from (e.g., data allocated to) storage device 192. Using this device data, management controller 152 may initiate performance of device management process 210 to infer whether storage device 192 has been, or is at risk of being, used in an unauthorized manner, and to manage operation of storage device 192 such that any further or future unauthorized use is prevented and/or otherwise mitigated.

Therefore, during management process 210 management controller 152 may facilitate performance of various processes and/or interactions using the device data obtained from storage device 192.

For example, to infer a status for storage device 192 that may indicate what may be defined as unauthorized use of storage device 192, a ledger (e.g., database, repository, etc.) of stolen storage devices (e.g., of any number of storage devices whose status with regard to having been stolen (i) remains inconclusive, (ii) has been confirmed, and/or (iii) has been denied) may be utilized.

For example, the ledger may include identifiers for each of the storage devices of various status, a previously determined status for each of the storage devices with regard to having been stolen, telemetry data of each storage device's respective host data processing system, types and/or quantities of data that a respective storage device was found to include in its stored content, actions taken to manage operation of each storage device, and/or any other information regarding the stolen storage devices, not to be limited by embodiments discussed herein.

Therefore, this ledger may be utilized to obtain relevant data regarding storage device 192 and/or otherwise used to infer a status of storage device 192. For example, once the status is inferred, what may be unauthorized use of storage device 192 may be more likely to be accurately identified and prevented. Such prevention may be based on any number of management actions performed to manage operation of storage device 192, thereby managing operation of the (distributed) system to which storage device 192 is operably connected.

For additional information regarding device management process 210, refer to the following discussions of FIGS. 2B-2D further below.

Turning to FIG. 2B, a second interaction diagram in accordance with an embodiment is shown. The second interaction diagram may illustrate a first instance of processes and interactions that may occur during a device management process (e.g., process 210 shown and discussed with regard to FIG. 2A).

As previously discussed with regard to FIG. 2A, management controller 152 may facilitate performance of processes and/or interactions using the device data obtained from storage device 192 (e.g., at interaction 202 in FIG. 2A). To infer a status for storage device 192 that may indicate whether storage device 192 is a stolen storage device, a ledger of stolen storage devices may be utilized. For example, such a ledger may be managed and/or stored with (e.g., hosted by) a second data processing system.

Assume, for example, that this second data processing system is where management system 102 is hosted, and that management system 102 is adapted to manage information stored in the ledger, utilization of the ledger, access to the ledger, etc.

Therefore, once the device data is obtained as discussed in FIG. 2A, management controller 152 may initiate additional out-of-band communication between itself and management system 102 (hosted by the second data processing system) to obtain information from, and/or access to, the ledger. In some cases, this interaction (e.g., 211) may include both the portion of the device data and/or a request regarding the ledger.

Thus, management controller 152 may initiate a transmission of data that may include at least a portion of the device data (e.g., the identifier).

At interaction 211, this transmission may be facilitated.

Interaction 211 may be facilitated by, for example, management controller 152's utilization of channel 172 in a manner that facilitates out-of-band communication with any number of other data processing systems (e.g., the second data processing system that hosts management system 102 and the ledger).

To do so, for example, management controller 152 may use channel 172 to communicate with network module 160 whose functionality may include facilitating, at least in part, communication with the other data processing systems and/or other devices of the other data processing systems (e.g., devices not included in data processing system 100A) within a distributed system.

Therefore, via channel 172, network module 160 may obtain the device data (and request) and relay it to management system 102 via an out-of-band data transmission based on the communication with management controller 152. It will be appreciated that the device data (and the request) shown in FIG. 2B are depicted with a line that spans from management controller 152, across network module 160, and terminating at an arrow on only one end oriented to point at a dotted wavy line. This dotted, wavy line may indicate the transmission being placed on route to, for example, management system 102.

For example, at interaction 211, management controller 152 may provide to management system 102 (e.g., discussed with regard to the (distributed) system of FIG. 1A), data such as the device data that was obtained from storage device 192.

This data may include, for example, the identifier used to discern storage device 192 from other storage devices, and/or a request for management system 102 to provide the relevant information from the ledger, provide a copy of the ledger, provide access to the ledger for management controller 152, and/or any other processes not to be limited by embodiments discussed herein.

Additionally, in some cases, for example, management controller 152 may further provide a request along with the data at interaction 211. Such a request may be for a copy of, and/or access to, the ledger be provided to management controller 152. This ledger may, for example, include information regarding any number of stolen storage devices, such as other identifiers respectively usable to discern each of the stolen storage devices from all other storage devices.

As previously discussed with regard to FIG. 2A, management system 102 may interact with data processing systems 100 (e.g., 100A) to obtain and/or provide information (e.g., recorded data) relevant to operation of data processing systems 100 (and/or components thereof).

Therefore, at interaction 212 and based on the data obtained via interaction 211, management system 102 may provide a response for management controller 152, this response being transmitted to network module 160 for relaying to management controller 152 via channel 172.

For example, the transmission at interaction 211 may be implemented (at least in part) by the previously discussed identifier for storage device 192. Management system 102 may then use the identifier to determine if a database/repository of stolen storage devices includes the identifier.

In some cases where the identifier is included, any information associated with the identifier (e.g., explicit information such as original ownership of storage device 192 and/or implicit information such as a likely timeline of storage device 192's usage) may be included in the response. In some other cases, the response may include a copy of information from the database/repository of stolen devices such as a list of the other identifiers of the other storage devices, access to such a database/repository as the ledger via management system 102, and/or other information not to be limited by embodiments discussed herein.

Based on the response obtained from interaction 212, management controller 152 may perform comparison-based process 220 to manage operation of storage device 192.

Assume, for example, that the previous response includes a copy of the ledger that is provided to management controller 152 at interaction 212.

Therefore, the response may include information associated with any number of questionably (e.g., based on respective statuses) stolen storage devices. For example, the ledger may include, for each of these stolen storage devices, (i) a status, (ii) a respective identifier, (iii) recommended management actions based on the status, (iv) information usable by management controller 152 for obtaining the status and/or the status-based recommendations regarding the management actions, and/or (v) any other information not to be limited by embodiments discussed herein.

For example, in this case where management controller 152 is provided the copy of the ledger, management controller 152 may use at least a portion of the device data to perform a lookup in the ledger. The lookup, for example, may be done using the previously discussed identifier to obtain an already known status and/or to obtain any information associated with the identifier (e.g., and therefore storage device 192) that may otherwise contribute to obtaining a likely accurate status for storage device 192. This identifier for example, may be compared to other identifiers included in the ledger, thereby making this management of storage device 192 be based on such comparisons (e.g., hence “comparison-based” process 220).

Assume, for example, that the identifier is matched via a comparison with one of the other identifiers in the ledger. Further assume that the one of the other identifiers is associated with a previous status of “confirmed stolen”.

In such a case where the status may be clearly associated prior to the operable connection of storage device 192 to data processing system 100A, management actions may be obtained based on the prior association and initiated by management controller 152 to manage operation of storage device 192.

It will be appreciated that management system 102 and/or management controller 152 may (i) obtain, and/or (ii) perform processes to obtain, any portion of what the above-mentioned response may include, rather than one or the other providing all of what the above-mentioned response may include. In some cases, for example, communications like that of interactions 211 and 212 may go back and forth as management system 102 and management controller 152 collaborate to obtain the status and status-based recommendations. For example, such a collaboration may be included as part of the performance of comparison-based process 220.

For additional information regarding comparison-based process 220, refer to FIG. 2D discussed further below. For additional information regarding device management process 210, refer to FIG. 2C, discussed below.

Turning to FIG. 2C, a third interaction diagram in accordance with an embodiment is shown. The third interaction diagram may illustrate a second instance of processes and interactions that may occur during the device management process discussed above with regard to FIG. 2B (e.g., process 210 shown in FIG. 2A).

As discussed with regard to FIG. 2B, information included in the ledger may be obtained to glean information regarding storage device 192. However, in some cases, management controller 152 may be unable to communicate out-of-band with management system 102. Consequently, management controller 152 may instead rely on locally stored data (e.g., a locally stored copy of the ledger).

Therefore, instead of such interactions as 211 and 212 discussed and shown with regard to FIG. 2B, local ledger-based lookup process 214 may be performed as shown in FIG. 2C and discussed herein. For example, rather than communication to obtain ledger associated information having to depend on functionality of network module 160 to facilitate the communication, such dependence may instead be on only management controller 152 and a physical address of the local storage allocated to keep a copy of the ledger.

Therefore, for example, to obtain a copy of the ledger, management controller may identify the allocated physical address of the copy of the ledger using an index adapted to keep track of storage location allocations. Once identified, management controller 152 may go look at the allocated data location and obtain the copy of the ledger.

Thus, once the copy of the ledger is obtained, management controller 152 may perform comparison-based process 220 as discussed with regard to FIG. 2B. For example, the identifier may be obtained, compared to the other identifiers from the ledger, and if a match between identifiers is observed, inferred to have a particular status that may then be used to manage operation of storage device 192.

Turning to FIG. 2D, a fourth interaction diagram in accordance with an embodiment is shown. The fourth interaction diagram may illustrate processes and interactions that may occur during a comparison-based process (e.g., process 220 shown in both FIGS. 2B and 2C).

As previously discussed, during comparison-based process 220, (i) status inferring process 222 may be performed, and (ii) unauthorized use prevention process 224 may be performed.

During status inferring process 222, for example and as previously discussed, the identifier associated with storage device 192 may (i) be obtained, (ii) compared to the other identifiers from the ledger, and (iii) if a match between identifiers is observed, inferred to have a particular status that may then be used to manage operation of storage device 192.

For additional information regarding alternate ways in which the status may be inferred, refer to the discussion of FIG. 3, further below.

Further assume, that similar to the discussion of FIG. 2B, storage device 192 is inferred to have a confirmed stolen status. Based on this inferred status, operation of storage device 192 may be managed. To do so, unauthorized use prevention process 224 may be performed.

During unauthorized use prevention process 224, the inferred status may be used to obtain at least one management action for managing the operation and (i) data may be transmitted to processor 190 at interaction 228, and/or (ii) data may be transmitted to the controller of storage device 192 and/or data may otherwise be managed for storage device 192 at interaction 226.

For example, since confirmed as being stolen, any data stored on storage device 192 may be at risk of unauthorized use and/or exposure (e.g., to a detriment of a rightful owner from which storage device 192 is confirmed stolen). Therefore, management controller 152 may obtain the at least one management action that may mitigate a likelihood of such unauthorized use and/or exposure of the rightful owner's data (e.g., the content stored of storage device 192).

To do so, for example, information associated with the matching identifiers from comparisons with the ledger may include any number of recommended management actions to be performed by (or at least initiated by) management controller 152.

Such management actions may include, but are not limited to (i) disabling the operation of the storage device so that the hardware resources are unable to interact with the storage device, (ii) encrypting at least a portion of data stored on the storage device using an encryption key that is unavailable to the hardware resources, and/or (iii) deleting at least a portion of data stored on the storage device so that the at least a portion of data is unavailable to the hardware resources.

At interaction 226, management controller 152 may transmit data to the controller of storage device 192. This data transmission may include commands, instructions, requests, etc. that specify to the controller what processes may be performed to implement the at least one management action, and how those processes may be performed.

Additionally (or alternatively), at interaction 228, data may be transmitted to processor 190 from management controller 152. This data transmission may include similar information as that mentioned above (to be transmitted at interaction 226) that specify to the processor what processes may be performed to implement the at least one management action, and how those processes may be performed.

Based on whether interaction 226 and/or interaction 228 may be performed, the controller of storage device 192 and/or processor 190 may facilitate the processes for the implementing of the at least one management action as specified by management controller 152.

For additional information regarding an inferring of a status for a storage device and/or regarding management of newly and operably connected storage devices, refer to the discussion of FIG. 3, below.

Thus, using processes and interactions shown in FIGS. 2A-2D, a new storage device may be discovered and identified using identifying information of the new storage device, be associated with an inferred status that is based on the identifying information, and have its operation managed based on the inferred status. By doing so, a likelihood of data stored on the storage device being used in an unauthorized manner (such as without a user's (to whom the data stored on the storage device is likely associated/belonging to) knowledge and/or consent, and/or with disregard for the user's privacy) may be decreased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrates a method that may be performed by the components of the (distributed) system of FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIGS. 1A-1C (e.g., management controller 152), and/or other components not to be limited by embodiments disclosed herein.

At operation 300, A management controller of the data processing system makes a determination that a new storage device is operably connected to hardware resources of the data processing system. The determination may be made by utilizing an infrastructure of the data processing system in which (i) the management controller operates independently from and is distinct from hardware resources of the data processing system, and in which (ii) the management controller is on a separate power domain from the hardware resources so that the management controller is operable while the hardware resources are inoperable.

For example, the management controller may discover (e.g., acknowledge, identify, etc.) the new storage device once the data processing system is powered on, causing the management controller and the new storage device to both receive power. Such a discovery may be facilitated over (e.g., via) various sideband (and independent from one another) communication channels that may respectively allow communication to any portion of the hardware resources from the management controller. For example, this determination (e.g., identification, discovery, etc.) regarding operable connection to the new storage device may occur during a discovery process as discussed with regard to FIG. 2A.

Based on the above-mentioned determination, the management controller may utilize any of the various sideband channels to perform further operations, for example, as discussed below.

At operation 302, the management controller obtains, based on the determination and via a sideband channel, data usable to identify whether the (new) storage device is a stolen storage device. The management controller may obtain this data by (i) requesting the data from the storage device, and (ii) based on the request, obtaining that data from the storage device.

This data may include, for example, an identifier usable to uniquely discriminate the storage device from all other storage devices. Such an identifier may be implemented by a string of letters, numbers, and/or symbols, the string being unique to the storage device (e.g., the string being distinct from other strings respectively associated with, and/or respectively used to identify, other storage devices).

Additionally, for example, this data may either further include, or may alternatively include, at least one portion of content from the storage device. For example, the at least one portion of content may be implemented by a collection of media files that include photos/videos of any number of individuals. Alternatively, for example, the at least one portion of content may be implemented by documents that include any number of email addresses, phone numbers, and/or other types of information that may be associated to any number of individuals (e.g., the individuals that may be included in the aforementioned photos/videos).

At operation 304, The management controller manages operation of the storage device based on an inferred status of the storage device that is based on the data.

This operation may be managed by, for example, comparing the identifier to a ledger of identifiers of stolen storage devices to confirm whether the storage device is the stolen storage device.

Although discussed with regard to “a ledger of identifiers”, it will be appreciated that the identifier may be compared to any number of such identifiers (of, for example, stolen storage devices) that may be accessible, looked up, and/or otherwise recorded for any number of intended and/or unintended uses in any manner and/or in any number of ways not to be limited by embodiments discussed herein.

In a first instance of the comparing, for example, where the storage device is the stolen storage device, at least one management action may be performed to limit impacts of unauthorized distribution of data stored on the storage device.

The at least one management action may include, for example, (i) disabling the operation of the storage device so that the hardware resources are unable to interact with the storage device, (ii) encrypting at least a portion of data stored on the storage device using an encryption key that is unavailable to the hardware resources, and/or (iii) deleting at least a portion of data stored on the storage device so that the at least a portion of data is unavailable to the hardware resources.

However, it will be appreciated that there may be instances where the storage device may not be capable of being confirmed as the stolen storage device. For example, in such instances, the storage device may be neither confirmed as being the stolen storage device nor confirmed as not being the stolen storage device. Such instances may result from, for example, cases in which the previously mentioned identifier (i) may be otherwise unavailable to the management controller, and/or (ii) may not be included in “the ledger” (e.g., prior to the comparing).

Consequently, in a second instance of the comparing where the storage device is neither confirmed as being the stolen storage device nor not being the stolen storage device, for example, at least one second management action may be performed.

This at least one second management action may include, for example, facilitating a collection of information regarding use of the storage device to proactively manage undesired activity in an event that it is determined in the future that the storage device is the stolen storage device.

For example, the at least one portion of content may be compared to portions of content from the hardware resources to confirm whether the storage device is the stolen storage device. For example, in an instance of the comparing where the storage device is the stolen storage device, at least one management action may be performed to limit impacts of unauthorized distribution of data stored on the storage device.

The method may end following operation 304.

Using the method shown in FIG. 3, a likelihood of data stored on the storage device being used in an unauthorized manner (such as without consent of an individual to whom the stored data on the storage device belongs and/or without regard to the individual's privacy) may be decreased.

Any of the processes and/or components illustrated in and/or discussed with regard to FIGS. 1A-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making by a management controller of the data processing system, a determination that a new storage device is operably connected to hardware resources of the data processing system; and
based on the determination:
obtaining, by the management controller and via a side-band channel, data usable to identify whether the storage device is a stolen storage device; and
managing, by the management controller, operation of the storage device based on an inferred status of the storage device that is based on the data.

2. The method of claim 1, wherein the data is an identifier usable to uniquely discriminate the storage device from all other storage devices.

3. The method of claim 2, wherein managing the operation of the storage device comprises:
comparing the identifier to a ledger of identifiers of stolen storage devices to confirm whether the storage device is the stolen storage device; and
in an instance of the comparing where the storage device is the stolen storage device:
performing at least one management action to limit impacts of unauthorized distribution of data stored on the storage device.

4. The method of claim 3, wherein the at least one management action comprises:
disabling the operation of the storage device so that the hardware resources are unable to interact with the storage device.

5. The method of claim 3, wherein the at least one management action comprises:
encrypting at least a portion of data stored on the storage device using an encryption key that is unavailable to the hardware resources.

6. The method of claim 3, wherein the at least one management action comprises:
deleting at least a portion of data stored on the storage device so that the at least a portion of data is unavailable to the hardware resources.

7. The method of claim 3, wherein managing the operation of the storage device further comprises:
in a second instance of the comparing where the storage device is neither confirmed as being the stolen storage device nor not being the stolen storage device:
performing at least one second management action to collect information regarding use of the storage device to proactively manage undesired activity in an event that it is determined in the future that the storage device is the stolen storage device.

8. The method of claim 1, wherein the data is at least one portion of content from the storage device.

9. The method of claim 8, wherein managing the operation of the storage device comprises:
comparing the at least one portion of content to portions of content from the hardware resources to confirm whether the storage device is the stolen storage device; and
in an instance of the comparing where the storage device is the stolen storage device:
performing at least one management action to limit impacts of unauthorized distribution of data stored on the storage device.

10. The method of claim 1, wherein the management controller operates independently from and is distinct from the hardware resources.

11. The method of claim 10, wherein the management controller is on a separate power domain from the hardware resources so that the management controller is operable while the hardware resources are inoperable.

12. A non-transitory machine-readable medium having instructions stored therein, which when executed by a processor, cause the processor to perform operations for managing operation of a data processing system, the operations comprising:
making by a management controller of the data processing system, a determination that a new storage device is operably connected to hardware resources of the data processing system; and
based on the determination:
obtaining, by the management controller and via a side-band channel, data usable to identify whether the storage device is a stolen storage device; and
managing, by the management controller, operation of the storage device based on an inferred status of the storage device that is based on the data.

13. The non-transitory machine-readable medium of claim 12, wherein the data is an identifier usable to uniquely discriminate the storage device from all other storage devices.

14. The non-transitory machine-readable medium of claim 13, wherein managing the operation of the storage device comprises:
comparing the identifier to a ledger of identifiers of stolen storage devices to confirm whether the storage device is the stolen storage device; and
in an instance of the comparing where the storage device is the stolen storage device:
performing at least one management action to limit impacts of unauthorized distribution of data stored on the storage device.

15. The non-transitory machine-readable medium of claim 12, wherein the management controller operates independently from and is distinct from the hardware resources.

16. The non-transitory machine-readable medium of claim 15, wherein the management controller is on a separate power domain from the hardware resources so that the management controller is operable while the hardware resources are inoperable.

17. A system, comprising:
a processor; and
a memory coupled to the processor to store instructions, which when executed by the processor, cause operations for managing operation of a data processing system to be performed, the operations comprising:
making by a management controller of the data processing system, a determination that a new storage device is operably connected to hardware resources of the data processing system; and
based on the determination:
obtaining, by the management controller and via a side-band channel, data usable to identify whether the storage device is a stolen storage device; and
managing, by the management controller, operation of the storage device based on an inferred status of the storage device that is based on the data.

18. The system of claim 17, wherein the data is an identifier usable to uniquely discriminate the storage device from all other storage devices.

19. The system of claim 18, wherein managing the operation of the storage device comprises:
comparing the identifier to a ledger of identifiers of stolen storage devices to confirm whether the storage device is the stolen storage device; and
in an instance of the comparing where the storage device is the stolen storage device;
performing at least one management action to limit impacts of unauthorized distribution of data stored on the storage device.

20. The system of claim 17, wherein the management controller operates independently from and is distinct from the hardware resources.
